(19) United States
(12) Patent Application Publication
(10) Pub. No.: US 2023/0069565 A1
(43) Pub. Date: Mar. 2, 2023

(54) Systems and Methods for Doubles Detection and Mitigation

(71) Applicant: Nimble Robotics, Inc., San Francisco, CA (US)

(72) Inventors: Simon Kalouche, San Francisco, CA (US); George Marchman, San Francisco, CA (US); Jordan Dawson, San Francisco, CA (US); John Fudacz, Columbus, OH (US); Siva Chaitanya Mynepalli, San Francisco, CA (US)

(73) Assignee: Nimble Robotics, Inc., San Francisco, CA (US)

(21) Appl. No.: 17/412,905

(22) Filed: Aug. 26, 2021

(51) Int. Cl. B65G 47/91; B65G 1/137

(52) U.S. Cl. CPC B65G 47/917; B65G 1/1373; B65G 2203/0241; B65G 2203/041

(57) ABSTRACT

The technology is directed to training a system to generate pick instructions. A teleoperator system may receive data corresponding to a robot attempting a picking task including picking an item of an identified product type from a container. The data may include imagery of an end effector of the robot after the attempted picking task. The teleoperator system may display the imagery on a display and an input indicating whether the picking task was successfully or unsuccessfully performed by the robot may be received. The data may be labeled based on the input and transmitted to a processor for training a learning algorithm for use in generating future pick instructions.

### BACKGROUND

Fulfillment centers require systems that enable the efficient storage, retrieval, picking, sorting, packing and shipment of a large number of items of diverse product types. Inventory is typically stored and organized within the fulfilment center within a storage structure. Once an order is placed, a warehouse worker or robot is tasked with retrieving the ordered items from the storage structure.

To minimize the number of trips and the total distance that the warehouse worker or robot must travel to retrieve items from the storage structure for a given number of orders, the warehouse worker or robot often retrieves items pertaining to multiple orders in a single trip. Retrieving items in this manner necessitates that the items be brought to a picking station where they are picked into individual order containers which are subsequently shipped to the consumer.

A traditional picking station includes a monitor that displays pick and place instructions received from Warehouse Software (WS). The pick and place instructions may direct an operator to pick and place an item of a particular type into an order container designated for a specific customer. Manually picking and placing each of the retrieved items is labor-intensive and expensive. While it is understood that replacing human workers with pick and place robots would lower operating costs, pick and place robots are often less efficient than human workers in performing pick and place tasks. For example, after reading the pick and place instructions displayed on the monitor, a human worker will be able to ascertain the item type and the quantity of that item type that he or she has been instructed to pick and will immediately and accurately be able to grasp the desired item and place it in the appropriate order container.

Conventional pick and place robots, on the other hand, are less efficient than humans at quickly and effectively grasping a wide variety of items ranging in size, shape, weight, material and stiffness. Contemporary pick and place robots have begun to utilize end effectors which “grasp” an item via a suction force. It has been found that these suction-based end effectors can successfully grasp a greater range of inventory items.

Despite the recent improvements that have been made to pick and place robots, various drawbacks remain. For example, when the item is stored within a flexible membrane, such as a polybag (as is common within the clothing industry), the suction force can draw the polybag of multiple items into the end effector of the robot, thereby causing the robot to unintentionally grasp two or more items. In another example, an item packaged in a small box may be on top of another item packaged in a larger box. When the item packaged in the larger box is grasped by the robot, the smaller box may be carried on the larger box. In yet another example, the packaging of an item may have exposed adhesive that may cause another item to stick to the exposed adhesive. As such, the item stuck to the adhesive may be carried along when the packaging is grasped by the robot.

If the unintentionally grasped items were subsequently packed into an order container, a customer would receive multiple items even though he or she had only paid for a single item. The unintentional picking of two or more items is referred to herein as “doubles picking,” “picking doubles,” “a double pick” and the like. It will be appreciated that doubles picking, when compounded, would result in large monetary losses to the retailer.

To avoid these losses, pick and place robots perform additional steps to ensure that only a single item has been picked. In one example, a robot may utilize a sensor that measures the weight of a picked item which the pick and place robot can then compare to an expected weight of the item to determine if it has grasped a single item, or more than one item, prior to placing the picked item(s) in the order container. This additional step, however, requires that the retailer keep and update a large database encompassing the weight of each product type stored within the fulfillment center. This is a cumbersome task. Moreover, the additional weighing step reduces the efficiency of the pick and place robot.

### BRIEF SUMMARY

Aspects of the technology are directed to assisting robots in completing tasks through use of a teleoperator system. For example, one embodiment of the technology is directed to a method for training a system to generate pick instructions. The method may include receiving, by a teleoperator system, data corresponding to a robot attempting a picking task including picking an item of an identified product type from a container, the data including imagery of an end effector of the robot after the attempted picking task; displaying, by the teleoperator system, the imagery on a display; receiving, by the teleoperator system, an input indicating whether the picking task was successfully or unsuccessfully performed by the robot; labeling, by the teleoperator system, at least a portion of the data based on the received input; and transmitting, by the teleoperator system, the labeled data to a processor for training a learning algorithm for use in generating future pick instructions.

Another embodiment of the technology is directed to a system including a robot having an end effector; and a teleoperator system in communication with the robot. The teleoperator system may be configured to: receive data corresponding to a robot attempting a picking task including picking an item of an identified product type from a container, the data including imagery of an end effector of the robot after the attempted picking task; display the imagery on a display; receive an input indicating whether the picking task was successfully or unsuccessfully performed by the robot; label at least a portion of the data based on the received input; and transmit the labeled data to a processor for training a learning algorithm for use in generating future pick instructions.

In some embodiments the item is packaged in a flexible membrane.

In some embodiments the end effector of the robot is a suction-based end effector.

In some embodiments, the data further includes a grasping location corresponding to a location on a packaging of the item where the robot engaged the end effector during the attempted picking task.

In some embodiments, the picking task is performed in response to pick and place instructions transmitted to the robot, the pick and place instructions comprising the pick instructions and place instructions. In some examples, the teleoperator system instructs the robot to complete the transmitted place instructions after receiving an input indicating the picking task successful.

In some examples, the picking task is successful when the robot picks only an item of the identified product type.

In some examples, the picking task is unsuccessfully performed when the robot picks two or more items.

In some instances, the teleoperator system instructs the robot to return the two or more items to the container and further instructs the robot to perform an additional picking task.

In some examples, the additional picking task is the same task as the picking task, and the teleoperator system provides a grasping location to the robot, the grasping location corresponding to a location on a packaging of the item where the end effector of the robot will attempt to engage during performance of the additional picking task.

In some embodiments, the data further includes a set of requirements of the picking task, identification of product types in the container, location of an item within the container relative to the container and/or relative to another item within the container.

### BRIEF DESCRIPTION OF THE DRAWINGS

Various embodiments of the present disclosure are described herein with reference to the drawings. The figures depict embodiments of the present disclosure for purposes of illustration only. Alternative embodiments of the structures and methods illustrated herein may be implemented without departing from the principles or benefits of the disclosure as described herein.

FIG. 1 is an example system including a robot in accordance with embodiments of the disclosure.

FIG. 2 is an illustration of an example robot in accordance with embodiments of the disclosure

FIG. 3 is another illustration of an example robot in accordance with embodiments of the disclosure.

FIG. 4 is a flow chart illustrating the operation of a system in accordance with aspects of the disclosure.

FIGS. 5A-5D illustrate a robot performing an example picking task that results in a doubles pick in accordance with aspects of the disclosure.

FIG. 6 illustrates a flow diagram for training a machine learning algorithm in accordance with aspects of the disclosure.

FIGS. 7A and 7B illustrate a robot performing an example picking task using the machine learning algorithm in accordance with aspects of the disclosure.

### DETAILED DESCRIPTION

The technology disclosed herein relates to assisting robots in completing tasks. For example, a robot may autonomously attempt to complete a task, such as a pick and place task, to move an item from a first location to a second location, such as from a picking container to an order container. A teleoperator may monitor the progress of the robot as it progresses through the pick and place task to determine whether the robot picked only the intended item. In the event the robot inadvertently picks one or more unintended items, the teleoperator may intervene and instruct the robot to return the picked item(s) to the picking container or call for onsite support. As is further described herein, information associated with the failed picking attempts, along with information associated with successful picking attempts, may be used to train machine learning algorithms to generate more accurate pick and place instructions for the robot to perform in the future, thereby significantly reducing, if not eliminating, double picking.

As used herein, the term “container” encompasses bins, totes, cartons, boxes, bags, auto-baggers, conveyors, sorters, and other such places an item could be picked from or placed. To distinguish between containers from which items are to be picked and containers in which picked items are to be placed, the term “picking container” will be used to identify containers from where items are to be picked, and the term “order container” will be used to identify containers in which items are to be placed. Also, as used herein, the terms “substantially,” “generally,” and “about” are intended to mean that slight deviations from absolute are included within the scope of the term so modified.

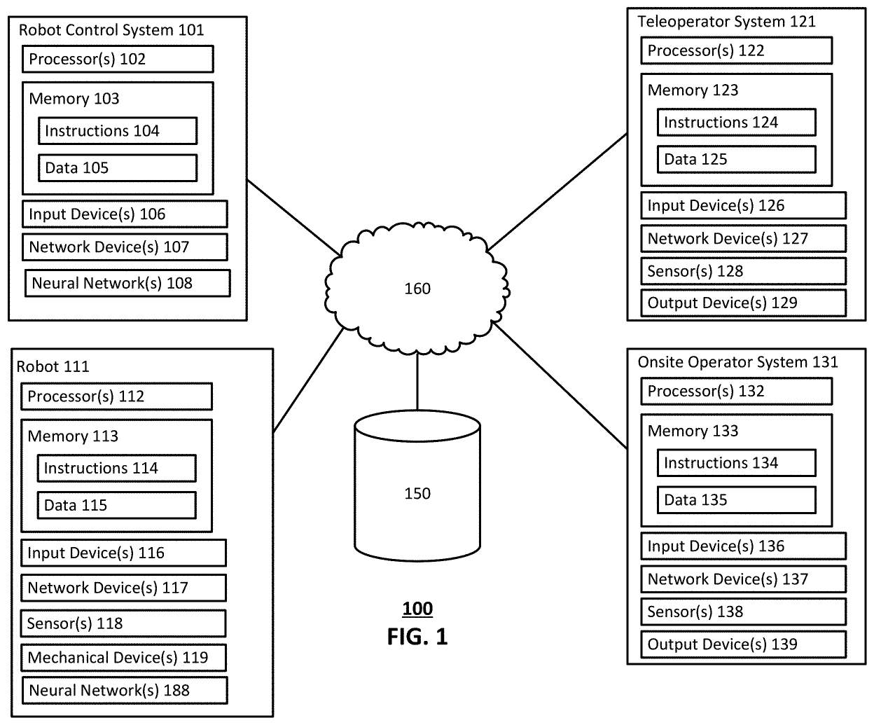

FIG. 1 illustrates a block diagram of a system 100 encompassing a robot control system 101, robot 111, teleoperator system 121, and operator system 131. Each of the systems, including the robot control system 101, robot 111, teleoperator system, and onsite operator system 131 are connected via a network 160. The system 100 may also include a storage device 150 that may be connected to the systems via network 160, as further shown in FIG. 1.

Although only one robot control system 101, one robot 111, one teleoperator system 121, one onsite operator system 131, and one storage device 150 are shown in FIG. 1, system 100 may include any number of systems and storage devices, as the number of robot control systems, robots, teleoperator systems, onsite operator systems, and storage devices can be increased or decreased. For instance, system 100 may include hundreds of robots 111 and one or more robot control systems 101 for controlling the robots, as described herein. The system 100 may also include a plurality of teleoperator and onsite operator systems to assist, monitor, or otherwise control the robots. Accordingly, any mention of teleoperator system 121, robot control system 101, onsite operator system 131, or storage device 150 may refer to any number of teleoperator systems, robot control systems, onsite operator systems, or storage devices.

Some embodiments of system 100 may have different components than those described herein. For instance, some embodiments of the system 100 may include only teleoperator system 121 but not onsite operator system 131, or onsite operator system 131 but not teleoperator system 121. Similarly, some or all of the functions of some of the systems and storage devices may be distributed among the other systems. For example, the functions of teleoperator system 121 may be performed by onsite operator system 131. In another example, the functions of robot control system 101 may be performed by robot 111, teleoperator system 121, and/or onsite operator system 131.

Robot control system 101 includes one or more processors 102, memory 103, one or more input devices 106, one or more network devices 107, and one or more neural networks 108. The processor 102 may be a commercially available central processing unit (“CPU”), a System on a Chip (“SOC”), an application specific integrated circuit (“ASIC”), a microprocessor, microcontroller, or other such hardware-based processors. In some instances, robot control system 101 may include multiple processor types.

Memory, such as memory 103, may be configured to read, write, and store instructions 104 and data 105. Memory 103 may be any solid state or other such non-transitory type memory device. For example memory 103 may include one or more of a hard drive, a solid-state hard drive, NAND memory, flash memory, ROM, EEPROM, RAM, DVD, Blu-ray, CD-ROM, write-capable, and read-only memories, or any other device capable of storing data. Data 105 may be retrieved, manipulated, and/or stored by the processor 102 in memory 103.

Data 105 may include data objects and/or programs, or other such instructions, executable by processor 102. Data objects may include data received from one or more components, such as other systems, processor 102, input device 106, network device 107, storage device 150, etc. The programs can be any computer or machine code capable of being executed by a processor, such as processor 102, including the vision and object detection algorithms described herein. The instructions 104 can be stored in any format for processing by a processor or in any other computing device language including scripts or modules. The functions, methods, routines, etc., of the programs for vision and object detection algorithms are explained in more detail herein. As used herein, the terms “instructions,” “applications,” “steps,” “routines” and “programs” may be used interchangeably.

The robot control system 101 may include at least one network device 107. The network device 107 may be configured to communicatively couple robot control system 101 with the other systems, such as teleoperator system 121, robot 111, onsite operator system 131, and storage device 150 via the network 160. In this regard, the network device 107 may be configured to enable the robot control system 101 to communicate and receive data, such as data received from robot 111, and other such signals to other computing devices, such as teleoperator system 121 and onsite operator system 131, or storage device 150. The network device 107 may include a network interface card (NIC), Wi-Fi card, Bluetooth receiver/transmitter, or other such device capable of communicating data over a network via one or more communication protocols, such as point-to-point communication (e.g., direct communication between two devices), Ethernet, Wi-Fi, HTTP, Bluetooth, LTE, 3G, 4G, Edge, etc., and various combinations of the foregoing.

Robot control system 101 may include one or more input devices 106 for interacting with the robot control system, robot 111, or other systems, such as teleoperator system 121 and onsite operator system 131. Input devices 106 may include components normally used in connection with a computing device such as keyboards, mice, touch screen displays, monitors, controllers, joysticks, and the like.

Robot control system 101 may exchange data 105 via an internal bus (not shown), network device 107, direct connections, or other such connections. In this regard, data 105 may be exchanged between the memory 103, storage device 150, processor 102, input device 106, and other systems, such as robot 111, teleoperator system 121, and onsite operator system 131.

Network 160 may include interconnected protocols and systems. The network 160 described herein can be implemented using various protocols and systems, such that the network can be part of the Internet, World Wide Web, specific intranets, wide area networks, or local networks. The network can utilize standard communications protocols, such as Ethernet, Wi-Fi and HTTP, proprietary protocols, and various combinations of the foregoing.

In some instances, robot control system 101 may be connected to or include one or more data storage devices, such as storage device 150. Storage device 150 may be one or more of a hard drive, a solid-state hard drive, NAND memory, ROM, RAM, DVD, CD-ROM, write-capable, and read-only memories, or any other device capable of storing data. The storage device 150 may store data, including programs and data objects such as vision and object detection algorithms. Moreover, storage device 150 may log data, such as information related to the performance of the robots, completed tasks, assistance request histories, etc. Although FIG. 1 illustrates storage device 150 attached to a network 160, any number of storage devices may be directly connected to any of the systems including the robot control system 101, robot 111, teleoperator system 121, and onsite operator system 131.

References to a processor, computer, or robot will be understood to include references to a collection of processors, computers, or robots that may or may not operate in parallel and/or in coordination. Furthermore, although the components of robot control system 101 are shown as being within the same block in FIG. 1, any combination of components of the robot control system may be located in separate housings and/or at different locations. For instance, robot control system may be a collection of computers, laptops, and/or servers distributed among many locations.

Each robot 111 may include one or more processors 112, memory 113 storing instructions 114 and data 115, input devices 116, network devices 117, sensors 118, mechanical devices 119, and neural networks 188. The processors 112, memory 113, input devices 116, network devices 117, and neural networks 188 may be similar to processors 102, memory 103, input devices 106, network devices 107, and neural networks 108 of the robot control system 101. The mechanical devices 119 may include mechanical components of the robot, such as wheels, picking arm, and end effectors, etc. As used herein, the terms “neural networks,” and “machine learning algorithms” will be understood to capture both the singular and plural. For instance, “neural networks” may include one neural network or a plurality of neural networks (e.g., two or more neural networks). Similarly, “machine learning algorithms” may include one machine learning algorithm or a plurality of machine learning algorithms.

As used herein, sensors 118 may include one or more image/video capture cards, cameras, including red-green-blue (RGB) or RGB-depth (D) cameras, video recorders, Light Detection and Ranging (LIDAR), sonar radar, accelerometers, depth sensors, etc. Such sensors may capture data in the environment surrounding the robot and/or information about the robot itself. The sensors 118 may be mounted to or within the robot 111. Such sensors 118 may also be spaced apart from the hardware of robot 111. In some instances, sensors spaced art from the hardware of robot 111 may be placed in the vicinity of the robot. As used herein, the terms “image” and “images” may include a single image, multiple images, videos, video stills, and/or multiple video stills.

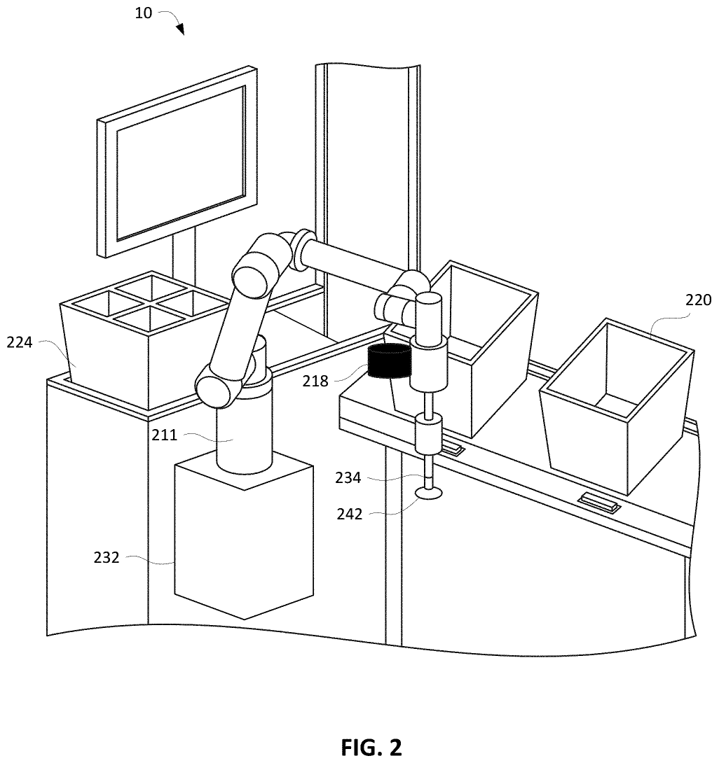

Robot 111 may be a stationary or mobile, manipulator robot (sometimes referred to herein as a “manipulator robot” or “robot”), designed to perform pick and place tasks within a warehouse or fulfillment center (hereinafter simply “warehouse”). FIG. 2 illustrates an example stationary pick and place robot 211 provided at a picking station within a warehouse 10. Robot 211 may include a base 232 and a picking arm 234 with an end effector 242 for manipulating and grasping items. Picking arm 234 is positionable to allow end effector 242 to reach into a picking container 224 and grasp the instructed item, and then move to place the grasped item in the desired order container 220. Although robot 211 is illustrated as having a single picking arm 234 and a single end effector 242, the robot may include any number of picking arms and end effectors. The end effector 242 may be a suction-based end effector such as a suction cup designed to grasp an item via a suction force. Robot 211 may be capable of swapping one end effector of a first size and shape for another end effector of another type, configuration, size and/or shape as described in U.S. Pat. Pub, No. 2021/0032034, which is incorporated herein by reference in its entirety.

Robot 211 may also include a camera 218, or other sensor, arranged to capture the environment of the picking arm 234 and end effector 242 as the robot performs a task such as a pick and place task. In this regard, the camera 218 may capture imagery of items as they are grasped by picking arm 234. The camera 218 may provide the imagery to robot control system 101 and/or directly to teleoperator system 121. Although FIG. 2 illustrates camera 218 as being attached to robot 211, the camera 218 may alternatively be spaced from the hardware of the robot and positioned in the warehouse 10 such that it captures the operation and the environment of the robot, as robot 211 performs a task. For instance, the camera may be positioned over picking container 224 such that the camera is arranged to capture imagery of robot 211 and the environment of the as it picks an item from the picking container 224.

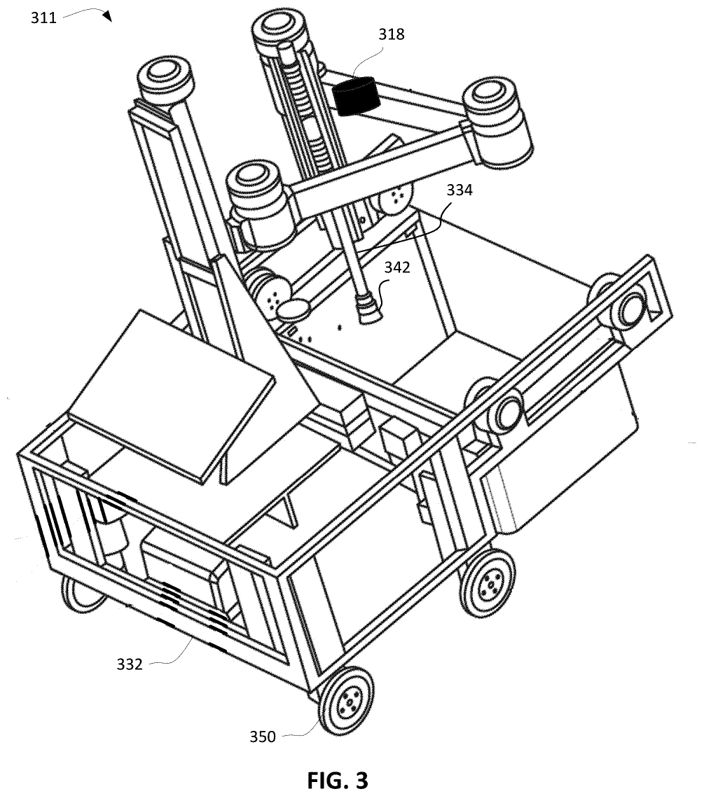

FIG. 3 illustrates an example of a mobile, manipulator robot 311. Like robot 211, mobile, manipulator robot 311 includes a base 332 and a picking arm 334 with an end effector 342 for manipulating and grasping items. End effector 342 may be a suction-based end effector designed to grasp an item via a suction force. Mobile, manipulator robot 311 further includes wheels 350 to allow the robot to move along a surface but other mechanisms for moving robot 311 may be possible. Like robot 211, robot 311 may also include a camera 318 (or other sensor), which may be compared with camera 218. Camera 318 may be positioned to capture imagery of the end effector 342 and the environment of the mobile robot 311, as robot 311 picks an item during a pick and place task. The camera 318 may provide the imagery to robot control system 101 and/or directly to a teleoperator system 121. Although FIGS. 1-3 illustrate the robots with a single camera, any number of cameras and/or other sensors may be used.

Robot 111 may operate in one of two modes: an autonomous mode, by executing autonomous control instructions, or a teleoperated mode, in which the control instructions are manually piloted (e.g., directly controlled) by a teleoperator, such as a remote teleoperator (e.g., a teleoperator located outside of the warehouse 10) or an onsite teleoperator (e.g., a teleoperator located within the warehouse 10). While the term “control instructions,” whether autonomous or piloted, is primarily described herein as instructions for assisting robot 111 in performing a pick and place task and, more specifically, determining if the robot correctly picked an item (e.g., did not inadvertently perform a doubles pick), it will be appreciated that the term “control instructions” may additionally refer to a variety of other robotic tasks such the recognition of an inventory item, the swapping of one end effector for another end effector, inventory counting, edge case identification, or any other robotic task that facilitates manipulation of objects or the environment in performing order fulfillment tasks, manufacturing tasks, assembly tasks, or other tasks. In one embodiment, robot 111 may be a machine learning robot capable of executing autonomous or piloted control instructions.

Robot 111 may send and/or receive processor readable data or processor executable instructions via communication channels, such as via network 160, to robot control system 101. In this manner, robot control system 101 can predict grasping poses (e.g., position and/or orientation and/or posture of the robotic picking arm) and send control instructions to robot 111 to execute the predicted grasping pose to autonomously grasp the item. Although robot 111 and robot control system 101 are illustrated as separate devices in FIG. 1, a robot control system can be integrated into the robot. In this regard, robot 111 may perform all of the functions of robot control system 101 without the assistance of a remote robot control system.

System 100 may further include one or more operator devices including a teleoperator system 121 and/or an onsite operator system 131. Teleoperator system 121 may be positioned within the warehouse in which the robots 111 are located or external to the warehouse, whereas onsite operator system 131 is positioned in the warehouse, such as in the vicinity of the robots 111. Each operator system, including teleoperator system 121 and onsite operator system 131 may include one or more processors 122,132; memory 123,133 storing instructions 124, 134 and data 125,135; network devices 127,137; and sensors 128,138; which may be similar to processors 102, memory 103, and network devices 107 of the robot control system 101, respectively. Sensors 128,138 may be similar to sensors 118 of robot 111.

Teleoperator system 121 and onsite operator system 131 may be personal computers, tablets, smart phones, wearable computers, or other such computing devices. Each of the operator systems may also include one or more input devices 126, 136 to capture control instructions from an operator. The one or more user input devices 126, 136 may be, for example, keyboards, mice, touch screen displays, displays, controllers, buttons, joysticks and the like.

A teleoperator may input synchronous (real-time) or asynchronous (scheduled or queued) control instructions to the teleoperator system 121. The control instructions may be, for example, click point control instructions, 3d mouse control instructions, click and drag control instructions, keyboard or arrow key control instructions, text or verbal instructions, action primitive instructions, etc. In some instances, sensors 128 may function as input devices, such as by capturing hand or body control instructions.

Each of the operator systems may also include one or more output devices 129, 139. Output devices may include displays, head mounted displays, such as smart glasses, speakers, and/or haptic feedback controllers (e.g., vibration element, piezo-electric actuator, rumble, kinesthetic, rumble motor). In some embodiments, the input and output devices of the operator systems may be the same device. For instance, the input and output devices of the teleoperator system 121 may be a touchscreen.

Teleoperator system 121 may be utilized by teleoperators, to monitor, control, and or assist the operation of robots 111. In this regard, teleoperators may visualize sensor data, such as imagery within images provided by robot sensors 118. As noted above, these images may include one or more individual images, videos, and/or stills from videos. The images may contain imagery of the robot and/or its environment, such as picking containers and order containers, as well as the items contained therein. These images may be replayed and/or viewed in real time. When robot 111 performs a task, an operator may utilize teleoperator system 121 or onsite operator system 131 to determine whether the task was performed successfully, thereby avoiding the need for the robot 111 or robot control system 101 to perform subsequent steps to determine if the task was successfully and correctly performed. By providing teleoperation capabilities via the teleoperator system 121, the neural networks 108 of robot control system 101 and/or neural networks 188 of robot 111 can be trained to generate improved control instructions (e.g., control instructions that result in more accurate picks and less double picking). Furthermore, if robot 111 is unsuccessful at autonomously performing the task, operators can utilize teleoperator system 121 to send control instructions to robot 111 to assist the robot in grasping an item and/or packing the item within the order container, for example, in a specific location of the order container or in a specific orientation. Teleoperator system 121 can thus be utilized by a teleoperator to assist robot 111 in properly performing certain edge case scenarios.

Other edge case scenarios may not be able to be corrected via teleoperation and/or cannot be corrected in an efficient manner via teleoperation. In these situations, onsite operator system 131 may provide an onsite operator with a notification that their assistance is required to handle these edge cases. As described herein, these notifications may be provided by teleoperator system 121, robot control system 101, and/or robot 111. By providing onsite operators with assistance notifications via onsite operator system 131, efficient handling of these edge cases is possible. For instance, onsite operator system 131 may receive a notification when maintenance of robot 111 is required, for example, when the system detects a failure in one of the hardware components of the robot such as the picking arm, the wheel, or the camera. In another example, onsite operator system 131 may receive a notification when an object is blocking the path that a robot needs to traverse to complete a task and that the object needs to be cleared. In yet another example, onsite operator system 131 may receive a notification that a robot needs assistance with inventory that has fallen outside the reach of the robot. In some embodiments, like teleoperator system 121, onsite operator system 131 may be used to determine whether robot 111 correctly performed a pick and/or to assist robot 111 in performing a task such as a pick and place task.

In addition to the operations described above and illustrated in the figures, various operations will now be described. The following operations do not have to be performed in the precise order described below. Rather, various steps can be handled in a different order or simultaneously, and steps may also be added or omitted.

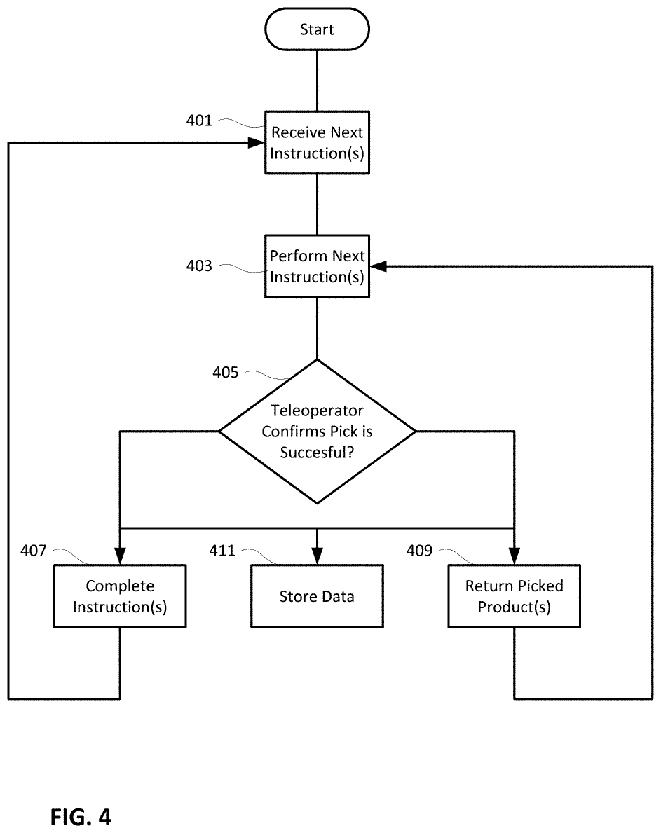

FIG. 4 is a flow diagram illustrating a robot, such as robot 111, performing a pick and place task. As shown in step 401, after receiving a task from the WS, the robot may generate pick and place instructions. In some instances, robotic control system 101 may generate and transmit instructions, such as pick and place instructions to robot 111. In this scenario, the robotic control system 101 may receive the task from the WS, not the robot 111.

As shown in step 403, robot 111 attempts to perform the picking portion, or the “picking task,” of the received pick and place instructions. The picking task may include picking an item from a picking container.

Upon completion of the picking task, the robot 111 may request approval from a teleoperator before proceeding with the remainder of the pick and place task, as shown in step 405. In this regard, the robot 111 or robot control system 101 may send a request or notification to a teleoperator system, such as teleoperator system 121, to confirm that the pick was successful. The request or notification may include an image feed that includes imagery captured by a sensor 118, such as a camera. The image feed may include imagery of the end effector of the robot and/or the item(s) picked by the end effector.

Upon receiving the request or notification through teleoperator system 121, the teleoperator may review the image feed to determine whether the correct item and only the correct item was picked by robot 111. In the event, the teleoperator determines the pick was successful (e.g., only the correct item was picked), the teleoperator may confirm that the pick task was successfully performed and instruct robot 111, using teleoperator system 121, to complete the pick and place task, as further illustrated by step 407 in FIG. 4. On the other hand, if the teleoperator determines the pick was not successful (e.g., the robot unintentionally picks additional items or the robot does not pick the correct item), the teleoperator, using teleoperator system 121, may instruct robot 111 to return the picked item(s) to the picking container, as illustrated by step 409. The robot 111 may then return the previously picked items to the picking container before again attempting to correctly perform the pick and place task, thereby repeating steps 403 and 405 as described above. When the pick and place task is performed successfully, robot 111 may perform its next assigned task, request a new task, or otherwise wait for a new task to be assigned, as further shown in step 401.

As illustrated by step 411 in FIG. 4, data corresponding to successful picking tasks and unsuccessful picking tasks may be stored and subsequently used for training machine learning algorithms. The data may include images showing the locations of inventory items within the picking container prior to the picking attempt (relative to other items and relative to the container), images captured during the picking attempt, the area of the inventory item that the end effector engages (“the grasping location”), the pose of the end effector as it engages the item, and/or other data generated during the picking attempt. Additional data may also be stored, such as data indicating: whether only the correct item was picked, the number of items the robot picked, whether the item was dropped by the robot before it was placed in the order container, whether or not a teleoperator assisted with the picking task, etc. The additional data may be generated by robot 111, robot control system 101, teleoperation system 121, or onside operator system 131. In this regard, teleoperator system 121 may query a teleoperator to provide and/or verify the accuracy of some or all of the additional data. The data may be stored internally within the robot, by robot control system 101, by teleoperator system 121, onsite operator system 131, and/or storage device 150.

The robot control system 101, or other such computing devices, may process the collected data to train machine learning algorithms, such as the neural networks 108 shown in FIG. 1. In this regard, the machine learning algorithms may be trained from the stored data to predict and generate pick and place instructions that are more likely to result in a successful pick and place. In other words, the trained machine learning algorithms may be used by robot control system 101 and/or robot 111 to predict future autonomous control instructions for robot 111 and other such robots, which results in more accurate picking, thereby reducing if not entirely eliminating doubles picking. Although FIG. 1 illustrates neural networks, any type of machine learning model may be used, such as convolutional neural networks, fully convolutional networks, multi-layer perceptrons, transformers, etc.

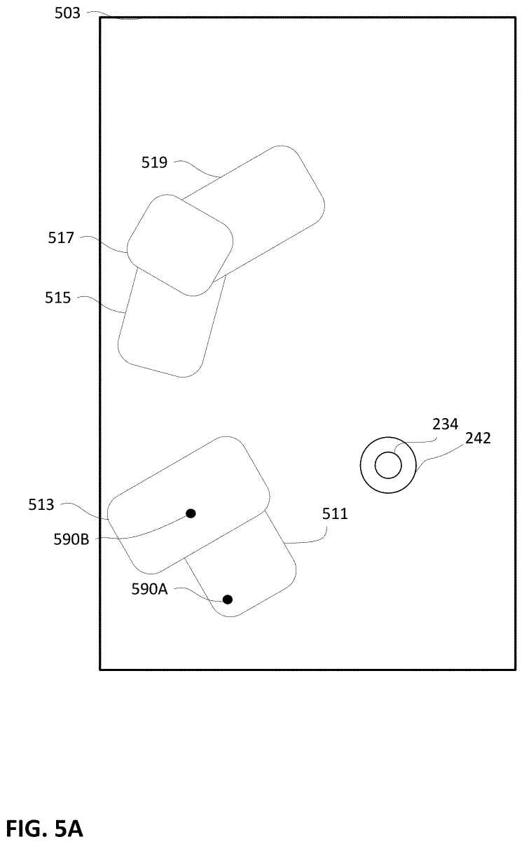

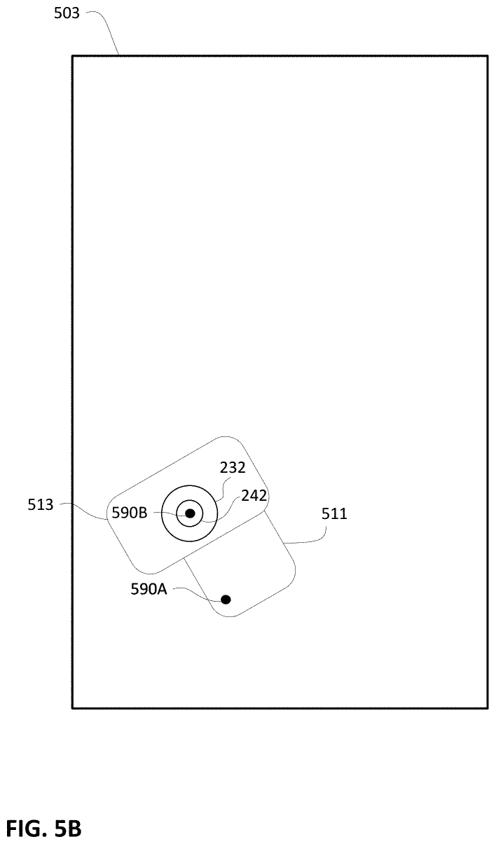

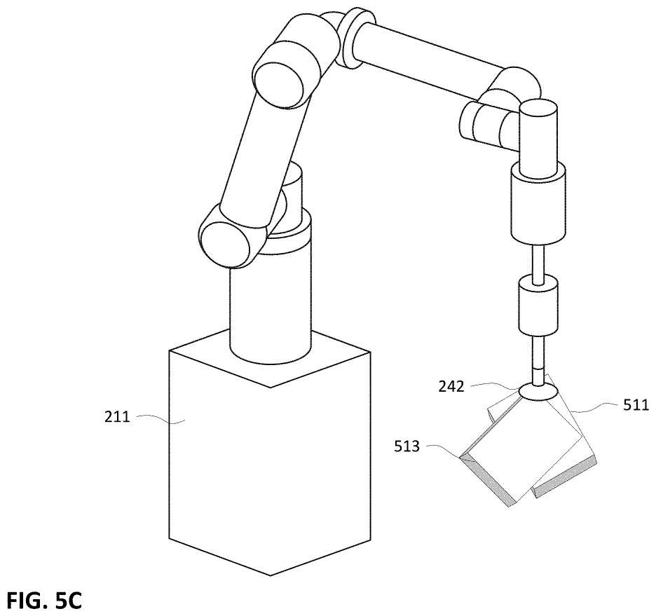

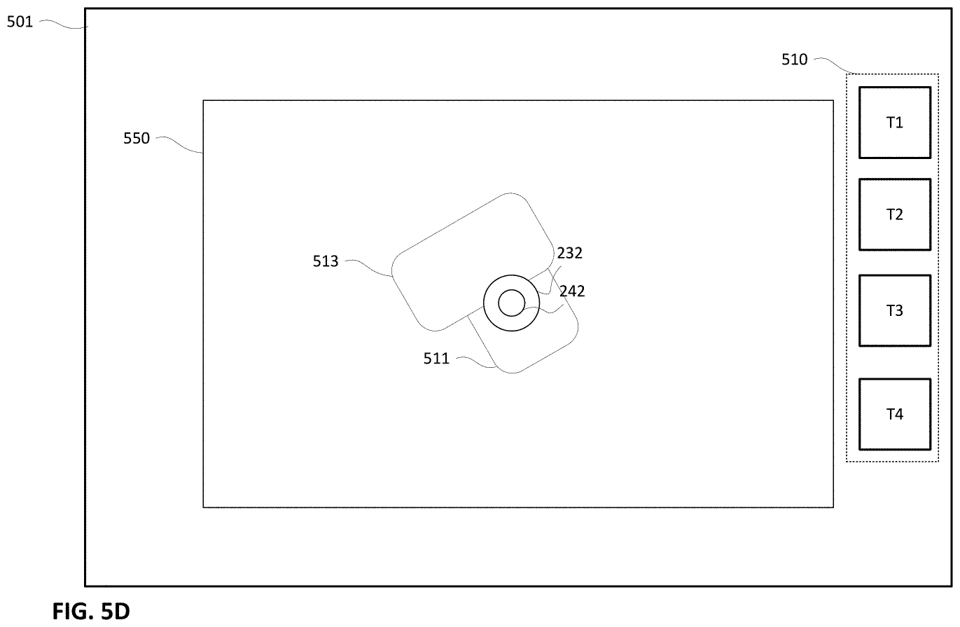

FIGS. 5A-5D illustrate robot 211 performing an example picking task in accordance with the flow diagram of FIG. 4. Robot 311, or any other manipulator robot, may perform a similar picking task in a similar manner. FIG. 5A illustrates an example image feed (e.g., a singular image, a series of images, and/or a video) provided by sensor 218 of robot 211. As shown in FIG. 5A, the image feed includes imagery of picking container 503 and items housed within the picking container, including items 511-519. The image feed further includes imagery of the suction-based end effector 242 and the arm 234 of robot 211 positioned above the picking container 503. Although not shown, the image feed may also include other objects in the environment of robot 211, such as an order container and/or items within the order container.

Some or all of the items, including items 511-519, may be stored within flexible or rigid packaging, such as polybags, cardboard boxes, plastic wrap, etc. Alternatively, some items may not be packaged or partially packaged. In this example, each of the items 511-519 are of the same product type and are individually stored within a polybag. Picking container 503 may contain several layers of densely packed and overlapping items. Nevertheless, for clarity, picking container 503 is illustrated as only including a few items, and specifically items 511-519, with item 513 partially overlying item 511. It will be appreciated, however, that the packaging of some items may be folded underneath itself or may be located underneath the packaging of other items, and, for this reason, some of the items 511-519 appear in different sizes. In other examples, the items may be of different product types.

Per step 401 of the flow diagram of FIG. 4, robot 211 may receive pick and place instructions from a robot control system, such as robot control system 101, or generate pick and place instructions based on a task received from the WS. FIGS. 5A-5C illustrate robot 211 performing a picking task (e.g., grasping one of the items from picking container 503) before the robot performs a placing task in which the grasped item is placed in an order container (not shown). Since the items in this example are all of the same product type, the picking instructions discussed herein do not and need not identify a specific item to pick (e.g., item 511, 513, 515, 517, or 519). The picking instructions may simply instruct robot 211 to pick one item from container 503. In other examples, the picking instructions may define a particular item or product type to pick from picking container 503.

To generate the pick and place instructions, the neural networks of robot control system 101 or robot 211 (e.g., neural network 108 or 188) may predict which item robot 211 has the highest likelihood of grasping and removing from picking container 503. In making such a determination, neural networks 108 or 188 may predict one or more grasping locations (e.g., areas of locations on the packing of an item accessible to the end effector 242 of robot 211) and/or one or more grasping pose candidates (e.g., position and/or orientation of the end effector 242) that it believes will lead to the end effector 242 of robot 211 successfully picking the item from container 503.

For example, neural network 108 of robot control system 101 or neural network 188 of robot 211 may determine that items 511 and 513 have the best chance of being picked based, in part, on the packing of items 515-519 overlying each other and/or the items' locations relative to sidewalls and/or partitions (not shown) of container 513. The neural networks 108 or 188 may predict that items 511 can be successfully picked if the item is grasped at grasping location 590A and that item 513 can be successfully picked if the item is grasped at grasping location 590B. The neural networks 108 or 188 may also predict one or more grasping pose candidates that may be sequentially performed as the end effector 242 of robot 211 approaches and engages items 511 or 513 at the predicted grasping locations.

The robot control system 101 and/or robot 211 may then implement a policy, which utilizes one or more metrics, checks, and filters to select one of the predicted grasping locations and/or one or more of the predicted grasping pose candidates for the robot 211 to execute. For example, based on the policy, the robot control system 101 or robot 211 may select grasping location 590B after determining that the probability of grasping and removing item 513 from container 503 by engaging the end effector 242 at grasping location 590B is higher than grasping and removing item 511 from the container by engaging the end effector at grasping location 590A. Robot control system 101 or robot 211 may then also select one or more of the predicted pose candidates that may be run in sequence to instruct the end effector 242 during the approach to grasping location 590B. The robot control system 101 or robot 211 may then generate pick and place instructions for the robot 211 to execute. The pick instructions may include the selected grasping location and the selected poses. The place instructions may include instructions on which order container to place the picked item.

As illustrated in step 403 of the flow diagram of FIG. 4, robot 211 may begin the picking task in accordance with the generated instructions. In instances where the robot control system 101 generates the instructions, the robot control system 101 may transmit the instructions to robot 211.

As illustrated in FIG. 5B, during the performance of the picking task, robot 211 may position the end effector 242 above the grasping location 590B on item 511. The grasping location 590B corresponds to the location where the end effector 242 will engage item 513 to attempt to grasp the item. As explained previously, the grasping location may be determined by the robot control system 101 using neural networks 108 or robot 211 using neural networks 188. Alternatively, the grasping location or the grasping poses may be collectively determined by the combination of the robot and the robot control system. In other examples, the grasping location may be provided by other devices, such as teleoperator system 121 or onsite operator system 131.

As is further shown in FIG. 5B, the grasping location 590B on item 513 is adjacent to item 511. When the suction-based end effector 242 approaches item 513, the suction force may be strong enough to pull the polybag of item 511 toward and into the end effector 242. As a result, the suction force applied by the end effector 242 results in a “doubles pick” of items 511 and 513, as shown in FIG. 5C.

After performing the picking task, the robot 211 may request approval from a teleoperator before proceeding with the remainder of the pick and place instructions, as shown in step 405 of FIG. 4. The request may include an image(s) captured by camera 218 after completion of the picking task. As shown in FIG. 5D, the image 550 captured by camera 218 may include the end effector 242 of robot 211, as well as items 511 and 513 within the grasp of the end effector. Image 550, which provides imagery of the grasped items (e.g., items 511 and 513) from a “top-down” perspective, is merely illustrative. The images provided to the teleoperator may be captured from any position relative to the items at the time of capture. For example, images may be captured from the side of the end effector 242 of robot 211. Moreover, the teleoperator may be provided with multiple images captured by the same or different sensors, such as additional cameras positioned around, on, and/or within the robot 211. In some instances, the robot may rotate the grasped items to provide different perspectives to the sensors. For example, the robot may rotate the grasped items 360 degrees, or more or less, to provide the sensors with the opportunity to capture imagery of the grasped items from many perspectives.

The request may also include information associated with the requirements of the picking task or the entirety of the pick and place task. This information may include identification of the product type to be picked and the order container in which the products are to be placed.

After receiving the request or notification through teleoperator system 121 (or onsite operator system 131), a teleoperator may review the images and other such data included in the request to determine whether only the correct item was picked or whether a doubles pick occurred. Continuing the example illustrated in FIGS. 5A-5D, the teleoperator system 121 may display image 550 for review by the teleoperator. Although not illustrated, the teleoperator system 121 may display, or be instructed to display, images captured from different perspectives than image 550. In some instances, the teleoperator system 121 may also display some or all of the information associated with the requirements of the picking task or the pick and place task. Based on the requirements of the picking task and image 550, a teleoperator may determine that the picking task was not completed successfully, as item 511 was inadvertently picked along with item 513 by robot 211. Accordingly, the teleoperator may provide an input into teleoperator system 121 indicating that the pick was not successful. The input may instruct robot 211 to perform a remedial measure such as dropping the picked items back into the picking container, as illustrated by step 409. Robot 211 may then return the picked items to the picking container before autonomously reattempting to perform the picking task, thereby repeating steps 403 and 405.

Although the remedial measure is described above as returning the picked item(s) to the picking container, in some instances the remedial measures may include sending a message to warehouse system or robot controller so that other measures may be taken. Alternatively, or simultaneously, the remedial measure may include instructing the robot to continue with the next task, such as a placing the picked items into an order container. In another example, the remedial measure may include instructing the robot to attempt to fix the grasp on the picked items(s), such as by moving the grasping location such that only the intended items is picked and the other item or items is released.

In some instances, robot 211 or robot control system 101 may request that the teleoperator assist the robot in performing the picking task. In other instances, the teleoperator may input picking instructions to robot 211 before robot 211 or robot control system 101 requests assistance if, for example, the teleoperator determines that piloted instructions may be more efficient. In this regard, and as is further illustrated in FIG. 5D, the interface 501 of teleoperator system 121 may further include an end effector selection section 510. End effector selection section 510 illustrates a collection of end effectors T1, T2, T3, and T4 available to robot 211 and which can be removably attached to end effector 242 such that the robot can swap one end effector for another end effect of a different size, shape, configuration, or type based on that end effectors' ability to grasp the product type the robot is tasked with grasping as is explained within U.S. Pat. Pub, No. 2021/0032034.

Although four end effectors are shown in the end effector selection section 510 of interface 501, the interface may display any number of end effectors, such as one, two, three, five, six, etc. The collection of end effectors shown on interface 501 may change based on the number of end effectors actually available to the robot 211 that is under control of teleoperator system 121. For instance, if a robot has two available end effectors, interface 501 may display only the two available end effectors. A teleoperator may select any of the end effectors presented in the interface for the robot to use to perform the task. In some examples, the interface may prevent or recommend to the teleoperator certain end effectors based on the capabilities of the end effectors to complete certain tasks. For instance, if robot control system 101 determines that a particular end effector is unlikely to successfully perform a certain picking task currently assigned to robot 211 based, for example, on the size, weight, material, or other properties of the product type or packaging of the item in which the robot is tasked with picking, the interface 501 may not display that particular end effector, or the interface may “gray out” the icon associated with that particular end effector. In another example, if a particular end effector is determined to be well suited for a particular task, interface 501 may provide a visual indication indicating such. For instance, the icon corresponding to the well-suited end effector may be highlighted or bolded. In some examples, the well-suited end effector may automatically be selected. Further, interface 501 may provide a visual indicator to illustrate which end effector is currently in use or otherwise attached to the robot 211.

The teleoperator may select a grasping location based on the imagery displayed within the interface of the teleoperator system 121, to assist robot 211 in completing the picking task. The selected grasping location may be provided to teleoperator system 121 via an input device 126, such as a mouse, keyboard, touchscreen, buttons, etc.

Irrespective of whether the picking task was autonomously performed, or performed with assistance from a teleoperator, as is shown in step 405 of FIG. 4, the teleoperator may determine whether the picking task was completed successfully or unsuccessfully. When the teleoperator determines that the picking task was completed successfully, the teleoperator may provide an input into the teleoperator system 121 indicating that the pick was successful. The input may trigger robot 211 to continue performing the remainder of the pick and place instructions, as shown in step 407 of FIG. 4.

In accordance with step 411 in FIG. 4, data corresponding to successful attempts and unsuccessful attempts may be stored for training a machine learning algorithm. For example, data related to the picking task such as the information associated with the requirements of the picking task or the entire pick and place task, the product types within the picking container, the locations of the items within the picking container (relative to the container (sidewalls and/or partitions) and relative to one another), the grasping location, and other data generated before, during, and/or after the picking task is performed by the robot, may be captured, recorded, and stored. Additional data may also be stored, such as data indicating: whether only the correct item was picked, the number of items the robot picked, whether the item was grasped at the targeted grasping location, whether the item was dropped by the robot before it was placed in the order container, whether or not a teleoperator assisted in performing the task, etc. The additional data may be generated by one of the components, such as the robot, the robot control system, the teleoperation system, etc., or by the teleoperator. In this regard, the teleoperator system 121 may query a teleoperator to provide and/or verify the accuracy of some or all of the additional data.

The data and/or the additional data may be stored internally within robot 111, by robot control system 101, teleoperator system 121, onsite operator system 131, and/or storage device 150. The data corresponding to an unsuccessful picking task may be labeled as such. Similarly, data corresponding to a successful picking task, including picking tasks where teleoperator system 121 piloted instructions, may be labeled accordingly.

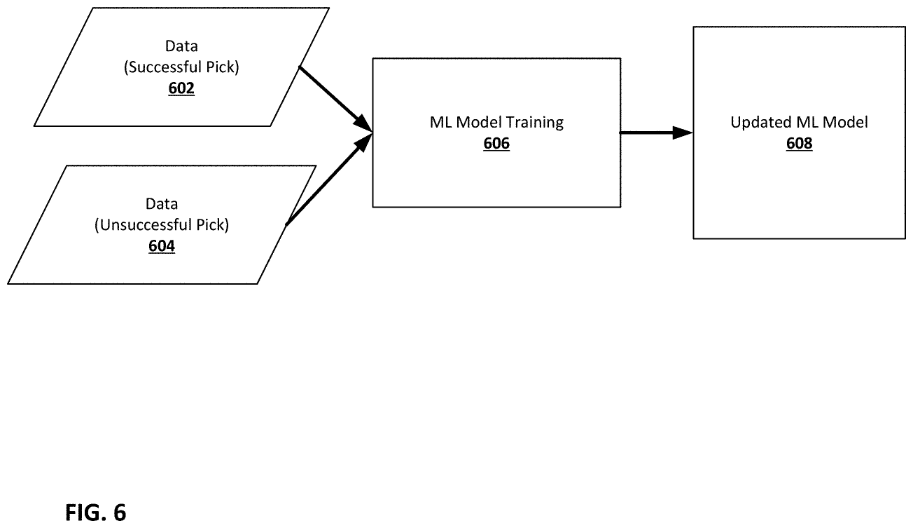

The robot control system 101 or other such computing devices may use the collected data to train a machine learning algorithm, such as neural networks 108, 188 shown in FIG. 1. In this regard, the machine learning algorithm may be trained from the data, such as the labeled successful picking task data 602 and the labeled unsuccessful picking task data 604, as illustrated in FIG. 6. The labeled data 602, 604 may be input into a machine learning model 606, which may use learning methods such as supervised, semi-supervised, unsupervised, or a combination thereof, to train the machine learning model to predict future grasping locations and grasping poses that will increase the accuracy of picking instructions and minimize doubles picking. For instance, the machine learning model may be trained using backpropagation with gradient descent to learn weights and/or other model parameter values that cause the machine learning model to output predictions most like the ground-truth labels (i.e., grasping locations that resulted in a successful pick and picks that did not include a doubles pick).

The machine learning model 606 may also be trained to identify successful and unsuccessful picks, from imagery of the picked item(s) captured within the images provided by the sensors positioned around, on, and/or within the robot. For instance, the labeled data 602, 604 may be input into a machine learning model 606, which may use learning methods to train the machine learning model to detect an unintentional doubles pick, detect that the correct item was picked, detect that the item was grasped at the targeted grasping location, detect that the picked item is in an appropriate orientation etc.

After training, the updated machine learning algorithm 608 may be stored and used to predict and select future grasping locations and grasping poses that will increase the accuracy of the picking instructions and minimize doubles picking. Further, the updated machine learning algorithm 608 may be used to identify unintentional doubles picks without the need for teleoperator review. For instance, neural networks 108 stored in robot control system 101 may be updated to include the updated machine learning model 608. In some instances, the updated machine learning algorithm 608 may be transmitted to robot 111 and used to update neural network 188. In some instances, the updated machine learning model may replace all existing neural networks.

In some instances, the updated machine learning model 608 may be stored by robot control system 101 or robot 111, such that the robot control system or the robot may use the updated machine learning model to predict future grasping locations or grasping poses when completing picking tasks. Yet further, the robot control system or the robot may use the updated machine learning model 608 to determine whether a picking task was successfully completed.

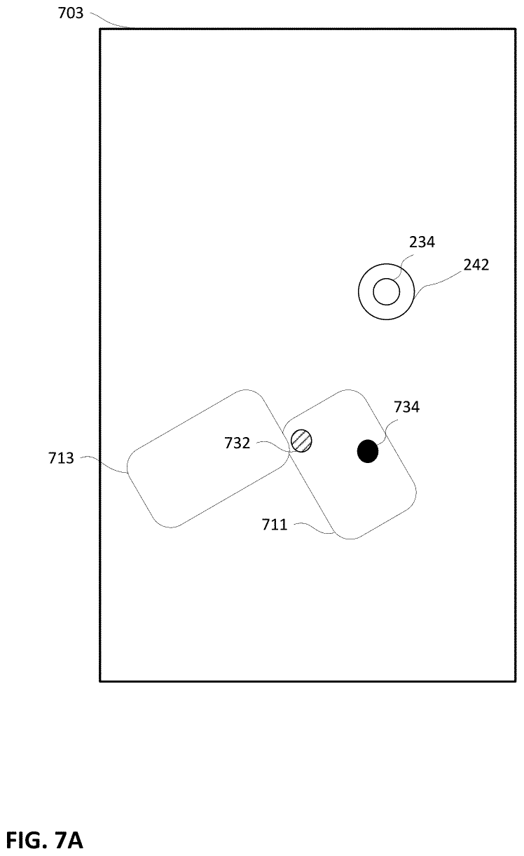

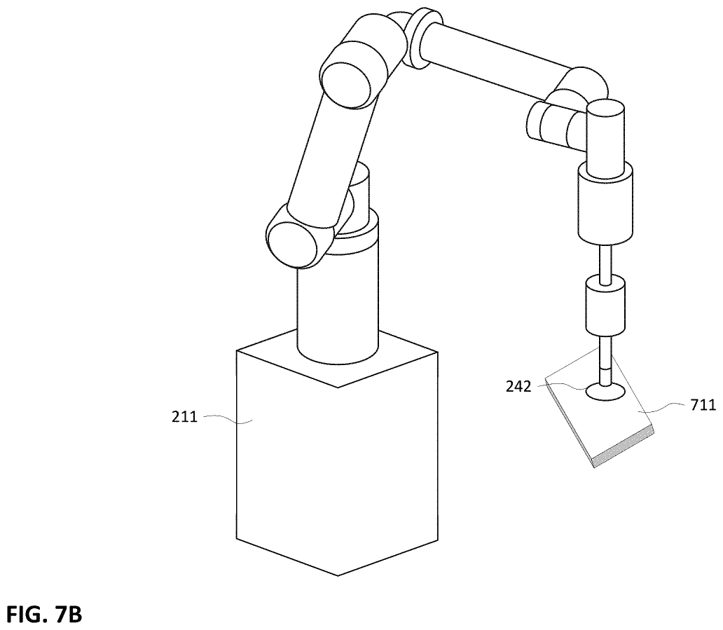

FIGS. 7A and 7B illustrate a successful autonomous picking task performed by robot 211, using the updated machine learning algorithm, in accordance with the flow diagram of FIG. 4. FIG. 7A illustrates an example image feed (e.g., a singular image, a series of images, and/or a video) provided by camera 218 of robot 211. As shown in FIG. 7A, the image feed includes imagery of picking container 703 and items in the picking container, including items 711 and 713 stored within a polybag. Picking container 703 is shown as only storing items 711 and 713 for clarity, but it will be appreciated that the container may ordinarily contain several layers of densely packed and overlapping items. The image feed further includes imagery of the suction-based end effector 242 and of robot 211 positioned above the picking container 703.

Per step 401 of the flow diagram of FIG. 4, robot 211 may receive or generate pick and place instructions, as described above. The performance of the pick and place task is illustrated by FIGS. 7A and 7B. The pick and place instructions include a picking task that provides instructions to pick an item within picking container 703 and placing instructions to move and place the picked item in an order container (not shown). After receiving or generating the pick and place instructions, robot 211 may begin the picking task, in accordance with step 403 of the flow diagram in FIG. 4. As further illustrated in FIG. 7A, the robot control system 101 (or robot 211) may use the updated machine learning model to predict one or more grasping locations, such as grasping locations 732 and 734, and/or one or more grasping pose candidates. Processor 102 may then implement a policy, which utilizes one or more metrics, checks, and filters to select one of the predicted grasping locations and/or to select one or more of the predicted grasping pose candidates for robot 211 to execute. While each of the grasping locations 732 and 734 are likely to result in the end effector 242 grasping product 732, the neural networks 108, 188 provided with the updated machine learning model 608 additionally evaluates the likelihood that each of the grasping locations will result in a doubles pick. Put differently, the updated neural networks 108, 188 predict and later select a grasping location and/or grasping poses by balancing the probability that the end effector 242 will be able to grasp an item and the probability that the grasping location will not result in a doubles pick.

In instances where the robot control system 101 selects a grasping location and/or grasping pose, processor 102 may transmit a signal including processor-readable information that represents the selected grasping location 734 and/or the selected grasping pose over network 160 to robot 211. Alternatively, processors 112 of robot 211 may run part of, or the entirety of, the grasping model to predict the one or more grasping locations and/or the one or more gasping poses rather than relying upon robot control system 101.

As shown in FIG. 7A, the grasping location 734 of item 711 is positioned away from item 713 and, thus, will allow the end effector 242 to successfully grasp item 711 while preventing the suction force from pulling the polybag of item 713 into the end effector 242 of robot 211. Moreover, the updated machine learning model 608 may predict and select a pose (e.g., the path) for the end effector 242 to use while approaching the grasping location that minimizes the likelihood of a doubles pick. As a result, a successful pick of item 711 is performed by robot 211, as illustrated in FIG. 7B.

Although the technology herein has been described with reference to particular embodiments, it is to be understood that these embodiments are merely illustrative of the principles and applications of the present disclosure. It is, therefore, to be understood that numerous modifications may be made to the illustrative embodiments and that other arrangements may be devised without departing from the spirit and scope of the present disclosure as defined by the appended claims.

1. A method for training a system to generate pick instructions, the method comprising:
receiving, by a teleoperator system, data corresponding to a robot attempting a picking task including picking an item, the data including imagery of an area near an end effector of the robot after the attempted picking task;
displaying, by the teleoperator system, the imagery on a display;
receiving, by the teleoperator system, an input indicating whether the picking task was successfully or unsuccessfully performed by the robot;
labeling, by the teleoperator system, at least a portion of the data based on the received input; and
transmitting, by the teleoperator system, the labeled data to a processor for training a learning algorithm for use in generating future pick instructions.

2. The method of claim 1, wherein the item is packaged in a flexible membrane.

3. The method of claim 1, wherein the end effector of the robot is a suction-based end effector.

4. The method of claim 1, wherein the data further includes a grasping location corresponding to a location on a packaging of the item where the robot engaged the end effector during the attempted picking task.

5. The method of claim 1, wherein the picking task is performed in response to pick and place instructions transmitted to the robot, the pick and place instructions comprising the pick instructions and place instructions.

6. The method of claim 5, further comprising:
instructing, by the teleoperator system, the robot to complete the transmitted place instructions after receiving an input indicating the picking task successful.

7. The method of claim 5, wherein the picking task is successful when the robot picks only an item of the identified product type.

8. The method of claim 5, wherein the picking task is unsuccessfully performed when the robot picks two or more items.

9. The method of claim 8, further comprising:
instructing, by the teleoperator system, the robot to return the two or more items to the container; and
instructing, by the teleoperator system, the robot to perform an additional picking task.

10. The method of claim 9, wherein the additional picking task is the same task as the picking task, and
wherein the teleoperator system provides a grasping location to the robot, the grasping location corresponding to a location on a packaging of the item where the end effector of the robot will attempt to engage during performance of the additional picking task.

11. The method of claim 1, wherein the data further includes a set of requirements of the picking task, identification of product types in the container, location of an item within the container relative to the container and/or relative to another item within the container.

12. The method of claim 1, further comprising:
receiving, by the robot, a second picking task;
generating, by the robot, using the learning algorithm, picking instructions for completing the second picking task; and
performing, by the robot, the picking instructions.

13. The method of claim 12, further comprising:
determining, by the robot, using a second learning algorithm, whether the performed picking instructions resulted in a doubles pick; and
upon determining a doubles pick was performed, conducting a remedial measure.

14. A system comprising:
a robot including an end effector; and
a teleoperator system in communication with the robot, wherein the teleoperator system is configured to:
receive data corresponding to a robot attempting a picking task including picking an item, the data including imagery of the area near an end effector of the robot after the attempted picking task;
display the imagery on a display;
receive an input indicating whether the picking task was successfully or unsuccessfully performed by the robot;
label at least a portion of the data based on the received input; and
transmit the labeled data to a processor for training a learning algorithm for use in generating future pick instructions.

15. The system of claim 14, wherein the item is packaged in a flexible membrane.

16. The system of claim 14, wherein the end effector of the robot is a suction-based end effector.

17. The system of claim 14, wherein the data further includes a grasping location corresponding to a location on a packaging of the item where the robot engaged the end effector during the attempted picking task.

17. The system of claim 14, wherein the picking task is performed in response to pick and place instructions transmitted to the robot, the pick and place instructions comprising the pick instructions and place instructions.

19. The system of claim 18, wherein the teleoperator system is further configured to instruct the robot to complete the transmitted place instructions after receiving an input indicating the picking task successful.

20. The system of claim 18, wherein the picking task is successful when the robot picks only an item of the identified product type.

21. The system of claim 18, wherein the picking task is unsuccessfully performed when the robot picks two or more items.

22. The system of claim 21, wherein the teleoperator system is further configured to:
instruct the robot to return the two or more items to the container; and
instruct the robot to perform an additional picking task.

23. The system of claim 22, wherein the additional picking task is the same task as the picking task, and
wherein the teleoperator system provides a grasping location to the robot, the grasping location corresponding to a location on a packaging of the item where the end effector of the robot will attempt to engage during performance of the additional picking task.

24. The system of claim 14, wherein the data further includes a set of requirements of the picking task, identification of product types in the container, location of an item within the container relative to the container and/or relative to another item within the container.

25. The system of claim 12, wherein the robot is configured to:
receive a second picking task identifying a quantity of a product to pick;
generate, using the learning algorithm, picking instructions for completing the second picking task; and
perform the picking instructions.

26. The system of claim 25, wherein the robot is further configured to:
determine, using a second learning algorithm, whether the performed picking instructions resulted in a doubles pick; and
upon determining a doubles pick was performed, conducting a remedial measure.

27. A method for detecting an incorrect pick by a robot, the method comprising:
receiving, by one or more processors, an image captured by a camera, wherein the image includes imagery of an area near an end effector of the robot after an attempted picking task;
providing, by the one or more processors, the image to a trained learning algorithm;
receiving, by the one or more processors, an indication of a successful pick or unsuccessful pick from the trained learning algorithm; and
(i) when the indication is of a successful pick, instructing, by the one or more processors, the robot to continue with the picking task or a next task; or
(ii) when the indication is of an unsuccessful pick, instructing, by the one or more processors, the robot to perform a remedial measure.
